(19) United States
(12) Patent Application Publication
(10) Pub. No.: US 2025/0198698 A1
(43) Pub. Date: Jun. 19, 2025

(54) Cryogenic-Based Carbon Dioxide Capture System

(71) Applicant: Southwest Research Institute, San Antonio, TX (US)

(72) Inventor: Douglas Carl HOFER, Clifton Park, NY (US)

(21) Appl. No.: 18/545,364

(22) Filed: Dec. 19, 2023

(51) Int. Cl. F25J 3/06; B01D 53/26

(52) U.S. Cl. CPC F25J 3/067; B01D 53/26; B01D 2257/80; F25J 2205/20; F25J 2210/70; F25J 2220/84; F25J 2240/02

(57) ABSTRACT

A system for capturing carbon dioxide from an industrial gas as a solidified carbon dioxide. The system directs an exhaust gas stream at an initial mean temperature to a compressor and a cooling assembly to bring the compressor stream down to an initial cooling temperature between the mean temperature and a de-sublimation temperature for the carbon dioxide gas in the stream. A work extraction mechanism is then used to condense the carbon dioxide from the stream into a solid form by work extraction and in substantial absence of surface accretion within the system.

### BACKGROUND

Carbon dioxide emissions, particularly from the combustion of fossil fuels and other industrial processes have been identified as potential contributors to environmental issues ranging from local pollution to global climate change. Thus, over the years, various efforts to mitigate and re-capture these emissions have been identified and attempted. For larger industrial processes, particularly where a flue is utilized to facilitate emissions, these efforts may include absorption with amines, adsorption, the use of membranes, calcium looping, biological-focused efforts and even cryogenic efforts.

Cryogenic carbon dioxide capture efforts have proven promising. However, given that efforts are directed at a stream of flue gas, such as through a flue, this means that a flue channel with physical inner walls is exposed to the stream throughout the process. So, for example, cryogenically cooling the flue gas means that the carbon dioxide within the stream will begin to condense as a solid below the triple point pressures and temperatures of about 5.17 bara and −56.56° C. This effectively facilitates a transition of the carbon dioxide from a gas to a solid state as dry ice. In theory, and in practice, this renders separation and collection of the carbon dioxide from the stream of flue gas as a practical undertaking.

Unfortunately, the described process involves a form of carbon dioxide condensation wherein the dry ice tends to accumulate at the inner walls of the flue. Further, even where other equipment is utilized, such as directing the stream of flue gas through heat exchangers or other equipment still renders a gas stream where condensing carbon dioxide has a tendency to accumulate at sidewalls of the channel utilized to direct the stream. This leads to clogging of the flue or other equipment which then requires system shutdown, maintenance and considerable expense along with loss of production time. Furthermore, utilizing more complex equipment or techniques that are not standard industry practice, may also present a variety of cost and training obstacles. Therefore, while cryogenic carbon capture techniques appear promising, operators often avoid the hassle of implementing such techniques in spite of the promising potential.

### SUMMARY

Embodiments of a cryogenic-based carbon dioxide capture system are detailed herein. For one embodiment an exhaust line for channeling a gas stream to a first cooling assembly is taught. The stream begins with an initial mean temperature and the stream includes carbon dioxide gas. The first cooling assembly is utilized to bring the stream temperature down to an initial cooling temperature below the mean temperature. A water extraction mechanism of the system is then utilized to remove condensed water from the stream. In one embodiment, a second cooling assembly is then utilized to bring a temperature of the stream further down to a temperature between the initial cooling temperature and closer to a de-sublimation temperature for carbon dioxide. A work extraction mechanism of the system may then be utilized to condense the carbon dioxide from the stream into a solid form by work extraction and in substantial absence of surface accretion within the system.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a schematic layout for an embodiment of a cryogenic-based carbon capture system.

FIG. 2 is a representation of a work extraction mechanism of the system of FIG. 1 receiving a gas stream and condensing carbon dioxide therefrom.

FIG. 3 is an overview depiction of an industrial site where the carbon capture system of FIG. 1 is employed.

FIG. 4A is a schematic layout for an alternate embodiment of a cryogenic-based carbon capture system where an additional condenser is employed.

FIG. 4B is a schematic layout for another alternate embodiment of a cryogenic-based carbon capture system where solid carbon dioxide is liquified for use within the system.

FIG. 5 is a flow-chart summarizing an embodiment of utilizing systems as described herein to attain solid carbon dioxide for extraction from a gas stream.

### DETAILED DESCRIPTION

Embodiments are described with reference to a particular cryogenic-based carbon capture system. Specifically, the embodiments depict a system where work extraction is utilized to condense carbon dioxide from a gas stream. In this manner, obtaining carbon dioxide in solid form may be achieved in a manner that avoids surface accretion. However, other configurations of the system may be utilized. For example, there may be options in utilizing multiple compressors, the extracted carbon dioxide in solid form may be liquified and re-used through the system for continued operation and a host of other system layout possibilities. Regardless, so long as the system achieves carbon-capture with a work extraction mechanism, as opposed to being a surface temperature based reduction, at the time of condensation, appreciable benefit may be realized in the substantial absence of surface accretion.

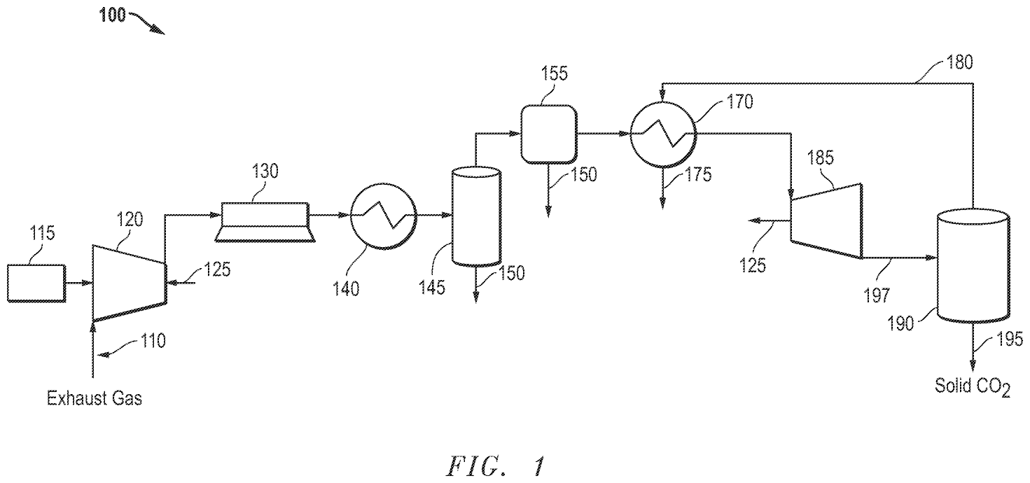

Referring now to FIG. 1, a schematic layout for an embodiment of a cryogenic-based carbon capture system 100 is illustrated. As with many industrial processes, the carbon dioxide gas is a natural byproduct or emission that presents as an exhaust gas 110 to be dealt with. Further, to manage the exhaust 110, it is routed to a compressor 120 that is driven by a driver 115 such as an electric motor to compress the exhaust gas to between about 3 and 10 bara. Additional power for the compressor 120 may be supplied by a shaft 125. For example, in the illustrated embodiment, some of this power for the shaft 125 may be drawn from a working or “work extraction” mechanism 185 that is utilized in condensing the carbon dioxide of the exhaust 110 into a solid form as detailed further below.

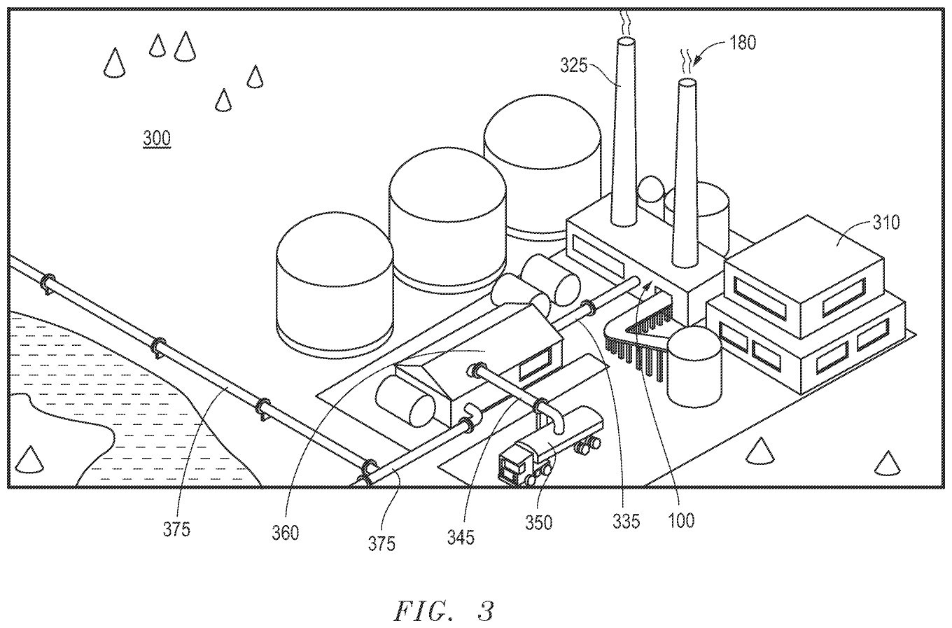

Ultimately, it is the work extraction mechanism 185, such as a turbo-expander, that presents a volumetric effect on the received gas stream to cool and condense without reliance on a cooling surface to achieve the cooling and condensation. As a result, condensation or accretion of carbon dioxide is not promoted at system surfaces. Thus, once the stream begins to present as a partially solid carbon dioxide stream 197, clogging or blocking of the flow with buildup is not promoted. Indeed, as illustrated at 195, upon routing through a mechanical separator 190, solid carbon dioxide may be drawn from the system for practical management and removal from the system 100. This leaves a clean emission 180 available for venting or other uses as described further below (e.g. see the clean emission 180 venting illustrated at FIG. 3). As used herein, the term “clean” emission is meant only to infer a substantially carbon-free form of emission as is the nature of the system 100. Of course, depending on operator preference, a beneficial system 100 may also be configured for carbon dioxide extraction from a gas stream in a manner that results in an emission that is less than substantially carbon-free as well.

Continuing with reference to FIG. 1, the manner in which the exhaust gas 110 is routed through the system 100 and presented to the work extraction mechanism 185 is illustrated in some detail. Individual equipment components and techniques primarily directed at temperature management are utilized so as to present a manageable stream to the work extraction mechanism 185 that is suitable for the formation of solid carbon dioxide that is readily available for capture and extraction. For the embodiment shown, once the compressed stream leaves the compressor 120 it is routed to a first cooling assembly, in this case, an air cooler 130 and a chiller 140 are utilized. The cooling of the stream may take the exhaust gas from an initial mean temperature down to somewhere above about 0° C. Heat from the stream may be rejected to ambient in the process.

Once reaching this initial cooling temperature, the stream may be directed to a mechanical separator 145 where newly formed liquid water 150 may be removed. Additional water 150 may be removed by flowing the stream through a process dryer 155. With water 150 substantially removed, the stream may be directed to a second cooling assembly in the form of a recuperator 170. The recuperator 170 may be a heat exchanger where additional cooling may take place down to a working temperature that remains above a de-sublimation temperature for the carbon dioxide in the stream. The use of two-stage cooling allows for the removal of water at a practical temperature short of ice formation followed by additional cooling to facilitate later carbon dioxide solidification.

By this point, just prior to reaching the work extraction mechanism 185 and even with two stages of cooling, the stream remains at a temperature that is still above a condensation temperature for the carbon dioxide, generally between about −75° C. and −120° C., depending on the carbon dioxide concentration in the stream. The cold pressurized stream, still above this condensation temperature for carbon dioxide, may now be directed to the work extraction mechanism 185 described above. It is of note that when the stream reaches the work extraction mechanism 185, a substantial amount of cooling has already occurred and the stream is within about 10° C.-50° C. of the condensation temperature for the carbon dioxide, perhaps entering at about −85 C. This means that the degree to which the work extraction mechanism 185 is relied upon to achieve the solidification of the carbon dioxide is within a manageable range that does not rely on surface-based temperature reduction to achieve the solidification. As a result, the work extraction which occurs in the mechanism 185 may reasonably attain the necessary condensation temperature of less than about −120° C. without encouraging accretion of solid carbon dioxide at surfaces of the mechanism 185 or anywhere else within the system 100 for that matter.

As described above, the work extraction mechanism 185 may then be utilized to convert the stream to a partially solid carbon dioxide stream 197. At this point, the stream 197 may be directed to a mechanical separator 190 for separation of the solid carbon dioxide 195 from the stream to achieve the sought carbon capture. As noted above, the remainder of the stream may be considered a clean emission 180 that is vented or, as illustrated, re-utilized back to the recuperator 170 where the cooled gas may further facilitate the process. Of course, other types of routing for the clean emission 180 may also be incorporated into the layout.

For the embodiment shown, the work extraction mechanism 185 may constitute a dynamic working device such as a condensing turbine. However, a positive displacement device such as a piston or other volumetric affecting device may also be utilized to extract work through a moving boundary as opposed to inducing a dramatic temperature variation in order to achieve the sought degree of de-sublimation for solidifying the carbon dioxide. Indeed, the likelihood is that the boundary surfaces of the moving portions of the work extraction mechanism 185 will actually be warmer than the primary stream that is being cooled. Therefore, accretion of de-sublimating carbon dioxide may actually be discouraged thereby keeping the system 100 substantially free of clogging for sake of continued operation. As noted above, the power available from the work extraction mechanism 185 may also naturally be a candidate for supplementing power to the shaft 125 for further driving the initial compressor 120 or for other supplemental purposes.

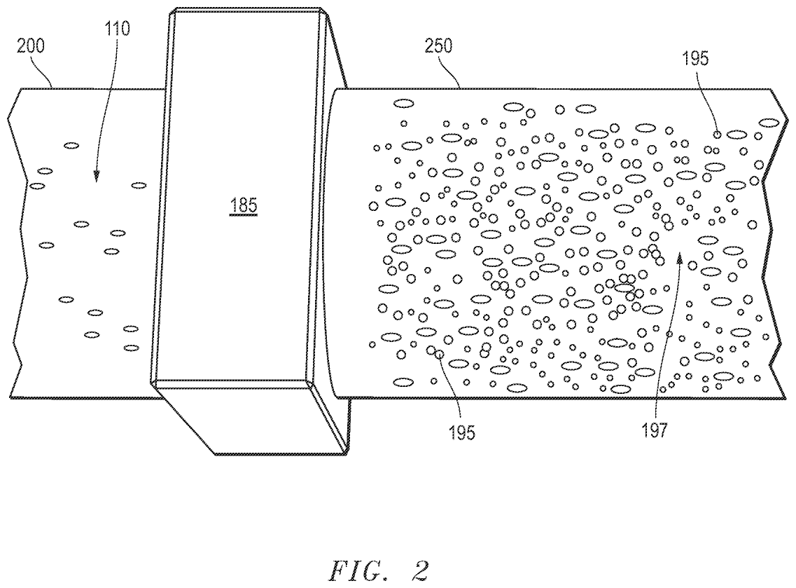

Referring now to FIG. 2, a representation of a work extraction mechanism 185 of the system 100 of FIG. 1 is illustrated in a visual schematic form. Specifically, a gas stream 110 is shown directed through a channeling structure 200 to the work extraction mechanism 185. The process described above occurs and the mechanism 185 is utilized to condense carbon dioxide from the stream as a solid 195. Of course, this is only a simplified illustration to highlight the work extraction process in achieving the solid carbon dioxide 195 for capture while keeping in mind that this occurs with less than a 60° C. temperature drop and without reliance on super-cooled surfaces which may be prone to accretion buildup and clogging. The work extraction mechanism 185 is not a heat exchanger or other similar device prone to such issues.

Referring now to FIG. 3, an overview depiction of an industrial complex or site 300 is shown where the carbon capture system of FIG. 1 is employed. This depiction is meant to represent a more real-world implementation of such a system 100. Specifically, where an industrial process facility 310 is prone to produce an exhaust gas 110 as noted in FIG. 1, this may be directed to the system 100 and ultimately vented as a clean emission 180 from a conventional stack 325. However, this emission 180 is substantially carbon-free. A solid dry ice form of carbon dioxide may then optionally be liquified and routed 335 to a management location 360. From here, the solid carbon dioxide may be liquified, if not already done so, and routed 345 to a transport vehicle 350 for off-site disposal or even more directly routed 375 for more local usage. Regardless, the solid carbon dioxide is now removed from the exhaust gas 110 and is no longer a part of the stream which may now be vented as a clean emission 180.

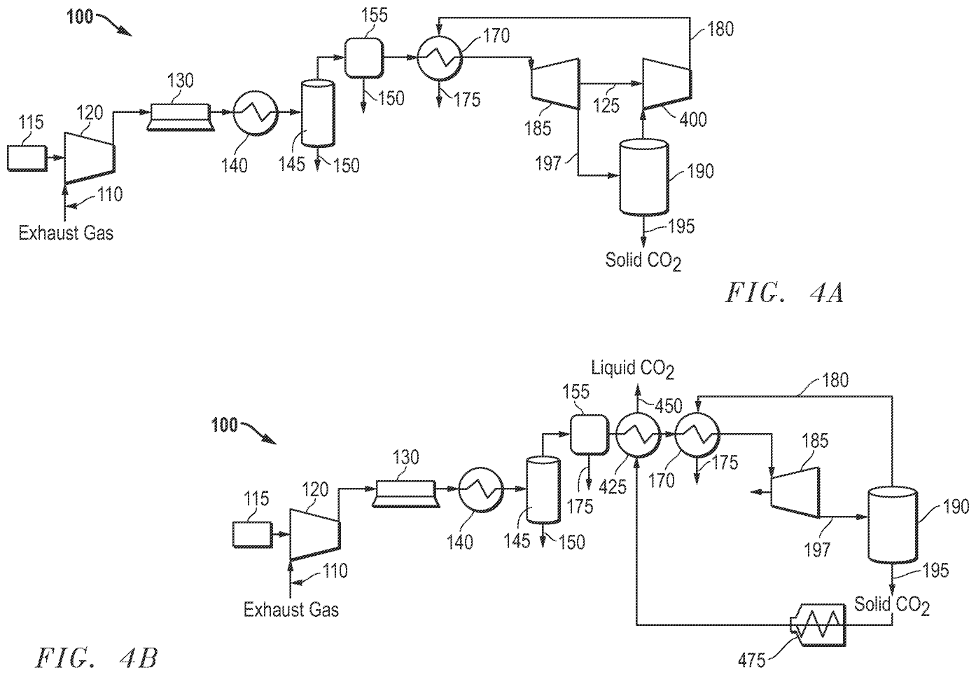

Referring now to FIG. 4A, a schematic layout for an alternate embodiment of a cryogenic-based carbon capture system 100 is illustrated where an additional compressor 400 is employed. For this version of the system 100, the same type of exhaust gas 110 routing is presented and managed with multiple cooling 130, 140, 170 stages are utilized leading to a work extraction mechanism 185 for carbon dioxide solidification and subsequent separation 195 at a separator 190. In turn, as the remaining clean emission leaves the separator 190 it may be partially diverted to a second compressor 400. Indeed, the clean emission 180 may also be at least partially routed from the separator 190 and initially to this second compressor 400. Thus, the cooled emission 180 may be used to further facilitate the recuperator 170 in the cooling process. Where the work extraction mechanism 185 is a condensing turbine, operating at similar low temperature and mechanics to the second compressor 400, a cooperative insulated package form of these components 185, 400 may be provided as a unitary assembly for user-friendly installation and use.

Referring now to FIG. 4B, a schematic layout for another alternate embodiment of a cryogenic-based carbon capture system 100 is shown where solid carbon dioxide 195 is liquified for use within the system 100. In this case, substantially the same type of exhaust gas 110 routing is presented and managed with multiple cooling 130, 140, 170 (and 425) stages that are utilized leading to a work extraction mechanism 185 for carbon dioxide solidification and subsequent separation 195 at a separator 190. However, once solidified, at least a portion of the solid carbon dioxide may be routed to a solid pump 475 and directed to another recuperator 425 within the layout. In this case, the second or supplemental recuperator 425 may be cooling the exhaust gas 110 as described above while also liquifying the solid carbon dioxide from the discretely depicted solid pump 475. This renders a liquid carbon dioxide 450 for removal or continued use within the system 100.

In one embodiment, the recuperators 170, 425 of FIG. 4B may be presented as a unitary assembly form of heat exchanger. In another embodiment, the supplemental recuperator 425 may be incorporated into an assembly with the solid pump 475. In either case, a more user-friendly and unitary installation package may be provided. Of course, the supplemental recuperator 425 form of the system 100 as illustrated in FIG. 4B may be utilized in conjunction with multiple compressors 120, 400 as illustrated in FIG. 4A. Additionally, a host of other layout modifications and additions may be employed for system optimization depending on the environment and the particular exhaust gas emission, among other factors. So long as the ultimate solidification and/or subsequent management of the carbon dioxide is facilitated by an effective work extraction device, appreciable benefit may be realized.

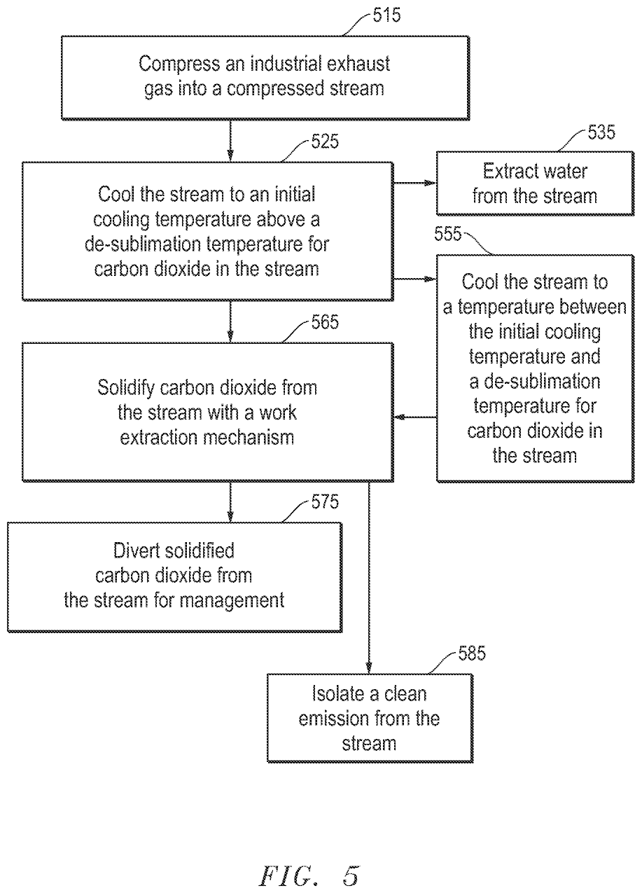

Referring now to FIG. 5, a flow-chart summarizing an embodiment of utilizing a work-extraction form of carbon capture system as detailed hereinabove is shown. Specifically, the system is used to manage an industrial gas stream as noted at 515. The stream is compressed and cooled to an initial cooling temperature that remains above a de-sublimation temperature for carbon dioxide in the stream as indicated at 525. For circumstances where water is then extracted from the stream as indicated at 535, this initial cooling temperature will be above 0° C. to help insure the water removal. However, with the substantial removal of water at a practical temperature above 0° C., additional cooling of the stream to a temperature between the initial cooling temperature and a de-sublimation or solid forming temperature for carbon dioxide is now available as indicated at 555. By way of a specific example only, where water is moved upon the initial cooling, this further lowered temperature may be between about 0° C. and about −80° C., depending on the pressure and carbon dioxide concentration in the stream.

With the stream now cooled and potentially having undergone a degree of water extraction, it is now ready for solidification where the carbon removal is facilitated by formation of carbon dioxide into a solid form. More specifically, the carbon dioxide solid may be achieved by a work extraction mechanism as indicated at 565. This is beneficial due to the fact that work extraction may achieve the de-sublimation without requiring surface interaction with the stream where the surface is colder than the stream. As a result, carbon dioxide solidification may be achieved without a tendency to promote accumulation of carbon dioxide on the surfaces of the work extraction mechanism. Therefore, solidified carbon dioxide may be separated from the stream as indicated at 575 without any accretion-based clogging of the work extraction mechanism. This leaves a clean emission available for isolation and venting or other uses (see 585).

Embodiments described hereinabove include a system and techniques for achieving carbon extraction from an industrial gas through a cryogenic process that avoids accretion of carbon dioxide at system surfaces. Thus, dry ice accumulation at the inner walls of a flue or other channeling is avoided. Additionally, the equipment utilized may be readily available and scalable, industry standard components that do not require a complete re-configuration of system layouts that would be unfamiliar to those in the field. Use of a turbine as the work extraction mechanism option may even present a compact assembly that opens up additional space in the facility footprint. Once more, the addition of amines or other unique chemicals, consumables or process materials is not required as with other carbon extraction methods is not required. Ultimately, a system of familiar industry equipment that is uniquely arranged and includes a work extraction mechanism for the eventual carbon dioxide solidification allows for effective carbon removal from industrial gas without surface accretion and clogging that could lead to the expenses of considerable downtime and/or the need for regular equipment replacement.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

I claim:

1. A cryogenic-based carbon dioxide capture system comprising:
an exhaust line for channeling a gas stream, the stream having an initial mean temperature and including carbon dioxide gas;
a cooling assembly fluidly coupled to the exhaust line to bring a temperature of the stream down to an initial cooling temperature between the mean temperature and a de-sublimation temperature for the carbon dioxide gas in the stream; and
a work extraction mechanism fluidly coupled to the cooling assembly to condense the carbon dioxide from the stream into a solid form by work extraction and in substantial absence of surface accretion within the system.

2. The cryogenic-based carbon dioxide capture system of claim 1 wherein the work extraction mechanism is one of a dynamic mechanism and a positive displacement mechanism.

3. The cryogenic-based carbon dioxide capture system of claim 2 wherein the dynamic mechanism is one of a condensing turbine and a turbo-expander and the positive displacement mechanism is a piston.

4. The cryogenic-based carbon dioxide capture system of claim 1 further comprising a compressor coupled to the exhaust gas line for compressing the stream to between about 3 bara and about 10 bara in advance of reaching the cooling assembly.

5. The cryogenic-based carbon dioxide capture system of claim 1 wherein the cooling assembly comprises one of an air cooler and a chiller.

6. The cryogenic-based carbon dioxide capture system of claim 1 wherein the cooling assembly is a first cooling assembly, the initial cooling temperature is above 0° C. and the system further comprises:
a mechanical separator to remove water from the stream;
a dryer to remove water from the stream; and
a second cooling assembly to bring the stream down to a working temperature between the initial cooling temperature and a de-sublimation temperature for carbon dioxide in the stream in advance of the stream reaching the work extraction mechanism.

7. The cryogenic-based carbon dioxide capture system of claim 6 wherein the second cooling assembly is a recuperator and the working temperature is between about −80° C. and about −120° C.

8. The cryogenic-based carbon dioxide capture system of claim 1 further comprising a separator coupled to the work extraction mechanism to divert solidified carbon dioxide from the stream and provide a substantially carbon-free emission for management.

9. An industrial site complex comprising:
a process facility for producing an exhaust gas at an initial mean temperature, the gas including carbon dioxide;
a cryogenic-based carbon dioxide capture system fluidly coupled to the process facility for receiving the exhaust gas and further comprising:
a cooling assembly to bring a temperature of the stream down to an initial cooling temperature between the mean temperature and a de-sublimation temperature for the carbon dioxide gas in the stream; and
a work extraction mechanism fluidly coupled to the cooling assembly to condense the carbon dioxide from the stream into a solid form by work extraction and in substantial absence of surface accretion within the system.

10. The industrial site complex of claim 9 further comprising a stack for release of the exhaust gas in a substantially carbon-free form.

11. The industrial site complex of claim 9 further comprising a management location for obtaining the solid carbon dioxide form for one of transport and local use.

12. A method of cryogenic-based carbon capture from an exhaust gas stream, the method comprising:
channeling the exhaust gas stream with an initial mean temperature to a cooling assembly to bring a temperature thereof down to an initial cooling temperature between the mean temperature and a de-sublimation temperature for the carbon dioxide gas in the stream; and
solidifying carbon dioxide from the stream with a work extraction mechanism.

13. The method of claim 12 further comprising compressing the stream at a compressor in advance of the channeling to the cooling assembly.

14. The method of claim 13 wherein the initial cooling of the stream is achieved with one of an air cooler and a chiller.

15. The method of claim 13 wherein the compressor is a first compressor and the method further comprises directing an emission of the stream from a separator coupled to the work extraction mechanism to a second compressor for one of facilitating cooling at the cooling assembly and facilitating cooling at another cooling assembly fluidly coupled to the work extraction mechanism.

16. The method of claim 15 wherein the second compressor is provided in a unitary form with the work extraction mechanism.

17. The method of claim 12 further comprising extracting water from the exhaust gas stream at the initial cooling temperature.

18. The method of claim 17 wherein the cooling assembly is a first cooling assembly, the method further comprising cooling the stream to a working temperature between the initial cooling temperature and a de-sublimation temperature for carbon dioxide in the stream at a second cooling assembly in advance of the solidifying of the carbon dioxide.

19. The method of claim 12 further comprising:
separating the solidified carbon dioxide from the stream;
liquifying the separated carbon dioxide; and
directing the liquified carbon dioxide to one of the cooling assembly, another cooling assembly coupled to the work extraction mechanism and a line for extraction of the carbon dioxide.

20. The method of claim 19 wherein the directing is powered by a solid pump that is one of discrete and unitary with one of the cooling assembly and the other cooling assembly.
